(19) United States
(12) Patent Application Publication
(10) Pub. No.: US 2011/0006205 A1
(43) Pub. Date: Jan. 13, 2011

(54) AMBIENT PRESSURE PHOTOELECTRON MICROSCOPE

(75) Inventor: Raymond Browning, Shoreham, NY (US)

Correspondence Address: Raymond Browning, 14 John Street, Shoreham, NY, 11786, US

(73) Assignee: Raymond Browning, Shoreham, NY (US)

(21) Appl. No.: 12/501,444

(22) Filed: Jul. 12, 2009

(51) Int. Cl. G01N 23/22

(52) U.S. Cl. 250/305; 250/306

(57) ABSTRACT

An ambient pressure photoelectron microscope which enables in situ chemical processes on a sample surface to be followed at the limit of the spatial resolution of the microscopy technique.

### TECHNICAL FIELD

The present invention relates generally to an ambient pressure photoelectron microscope. More particularly to an ambient pressure photoelectron microscope which enables in situ chemical processes on a sample surface to be followed.

### BACKGROUND INFORMATION AND DISCUSSION OF RELATED ART

X-ray photoelectron spectroscopy is used for understanding the surface state of material systems. A photoelectron experiment uses photons to excite the emission of electrons from the surface of a material into a vacuum where the energy of the electrons contains information about the chemistry of the surface. The kinetic energy of the emitted electron, E_{kinetic}, is related to the energy of the photon, Eₚₕₒₜₒₙ, by the relationship:

E_{binding}=Eₚₕₒₜₒₙ−E_{kinetic}−Φ

Where E_{binding} is the binding energy (BE) of the electron in the material and Φ is the work function. If the photon has sufficient energy it can cause electron emission into the vacuum from either a localized atomic level, a valency band, or a conduction level state in the material. Depending on the energy of the incident photon which can excite a range of different electronic transitions in the atoms and valency bands of the material, the resultant kinetic energy of the electron can provide detailed information about the atomic species and the chemical state of the material surface. When X-ray energies are used for excitation of core level electrons the techniques is known as X-ray photoelectron spectroscopy. The emitted energies in XPS are typically below 1.5 keV. Because of the chemical species and chemical state specificity the technique is also known as electron spectroscopy for chemical analysis or ESCA. The field of photoelectron spectroscopy can also use UV light as well as X-rays, and is generally referred to as PES. The electrons leave the surface with a range of energies depending on their individual history and losses in the surface of the solid. The energy of the photoelectrons leaving the sample is determined using an electron energy analyzer, usually a high resolution concentric hemispherical analyzer (CHA). Sweeping the analyzer with energy gives a spectrum with a series of photoelectron peaks. Typically X-ray energies are below 1.5 keV, and because photoelectrons with energies below 1.5 keV are strongly scattered by atoms, the range of the electrons in a material is very small. Therefore, the XPS spectrum represents the chemistry of the top few atomic layers of a material. The same strong scattering of electrons by gas molecules, hinders the application of XPS to measurements under gas atmospheres at pressures >10⁻³ Pascals(Pa), and for that reason XPS is conventionally performed under high-vacuum conditions.

Chemical processes at vapor/solid and vapor/liquid interfaces play a major role in many field such as catalysis, semiconductor manufacturing, and manufacturing of specialized surface treatments. To advance the science and develop applications in these fields, it is important to obtain a detailed knowledge of the atomic scale geometrical, and electronic structure of the interfaces as close as possible to real operating conditions of pressure and temperature. A host of phenomena including reactions in heterogeneous catalysis may depend on structures that are only stable in equilibrium with the high chemical potential of reaction gases. Over the past decades a number of surface-sensitive techniques have been used under elevated (>100 Pa) pressures, such as near edge X-ray absorption fine structure (NEXAFS) and X-ray photoemission spectroscopy (XPS).

Ogletree et al., in Nuclear Instruments and Methods in Physics Research Section A: Accelerators, Spectrometers, Detectors and Associated Equipment Volume 601, Issues 1-2, 21 March 2009, Pages 151-160, teach that in order to perform XPS experiments at pressures >10-3 Pa, the attenuation of the electrons due to scattering by gas molecules has to be kept at a minimum by minimizing the path length of the electrons in the high-pressure region. Ogletree et al. teach that this is conventionally achieved by placing the sample inside a reaction chamber and bringing the sample surface close to a differentially-pumped aperture, behind which the pressure drops by several orders of magnitude. Ogletree et al. teach that this basic concept has been used in all ambient pressure PES setups developed over the past forty years, starting with the designs by Kai Siegbahn and coworkers in the late 1960's, which were initially used for gas phase experiments. Many instruments are able to operate at pressures of about up to 100 Pa by using two or three differential pumping stages between the sample chamber and the electron analyzer. The pressure limit in ambient pressure photoelectron spectroscopy (APPES) is determined on one hand by the attenuation of the electrons by gas molecules, and on the other hand by the pressure differential between the sample chamber and the electron analyzer, which needs to be kept under high vacuum. As Ogletree et al. teach the upper pressure limit in APPES experiments can be increased by decreasing the size of the first aperture, which improves differential pumping as well as reducing the path length of the electrons through the high-pressure region. Furthermore, by focusing the electrons onto the differentially-pumped apertures using electrostatic lenses in the pumping stages, differential pumping is obtained without significant loss of signal. Ogletree et al. teach that this principle has been applied in a new generation of APPES instruments that are based at third generation synchrotrons. Such an instrument was developed at the Advanced Light Source in Berkeley in 1999 and the next generation of instruments was jointly developed a few years later by the Fritz Haber Institute (Berlin) and Lawrence Berkeley National Laboratory. The high brightness third generation synchrotrons provides tightly-focused, intense x-rays, which makes possible the use of small front aperture diameters of 0.3 mm (i.e. improved differential pumping) without loss of signal. Ogletree et al. teach that the combination of a differentially-pumped electrostatic lens system with a synchrotron light source led to a significant increase of the pressure limit in APPES. This is largely because the distance between the sample surface and the exit aperture can be reduced if the aperture diameter is reduced. It is clear from Ogletree et al. that considerable development went into the current art, and that the differential pumping arrangement incorporated into the electrostatic lenses of the spectrometer are of a complex design. The pressure cell technique therefore makes the equipment both expensive and not readily available for other experiments. In fact, it is clear that the current art with a special electron lens and several stages of differential pumping leads to a dedicated piece of equipment for APPES.

The several stages of differential pumping typically use a mechanical pump such as a turbo pump with a mechanical backing pump. The several stages of the differential pumping thus have vibration associated with them that would preclude high spatial resolution photoelectron microscopy of the sample in the pressure cell.

Although Ogletree et al. teach that an electrostatic lens is used that focuses electron through a differential pumping aperture they do not use an immersion lens around the sample because the high electrostatic field required for such an immersion lens would lead to breakdown and arcing at the ambient gas pressures used in these experiments. However, immersion lenses are valuable if it is desired collect as much of the available emitted electrons as is possible. One approaches to using an immersion lens is a development of the work of Beamson et. al., Nature Vol. 290, p. 556, 1981 and Turner U.S. Pat. No. 4,486,659. Beamson et. al. and Turner teach that an axially symmetric magnetic field can project a beam of photoelectrons towards a detector. This work was later developed by several authors with several variations in instrument design including Browning U.S. patent application Ser. No. 11/623,285 who teaches that the magnetic field can be terminated and an imaging electron energy analyzer can be used to study the specimen. With these instruments, an image of the area illuminated is projected as a real image along the length of the projection lens so that the electrons emitted at a point on the surface are constrained to a small area in the image at every point along the length of the projection lens. The instruments of Beamson et. al. and Turner, and Browning are described as photoelectron microscopes.

No prior art exists that teaches that an ambient pressure cell can be used with an efficient immersion lens. Prior art teaches that ambient pressure cells are differentially pumped, and are used in complex, single use, experimental arrangements.

What is desired, therefore, is an ambient pressure cell that has a small aperture so no differential pumping is required. Further, such an ambient pressure cell would be straightforward to use. Further, the pressure cell would ideally use a very efficient electron collection method to provide the spectroscopic analysis with a large signal that can be used with a wide range of electron analyzer types. Further, in the absence of differential pumping stages there would be a low level of vibration associated with the pressure cell and high resolution photoelectron microscopy would be enabled and in situ chemical imaging would be the result.

### SUMMARY OF THE INVENTION

It is an object of the invention to provide an ambient pressure photoelectron microscope for chemical imaging of in situ processes.

Accordingly the invention is characterized by an experimental apparatus comprising:
(a) a first means producing a magnetic field;
(b) an enclosure immersed in said magnetic field and containing an experimental sample;
(c) a second means to introduce an ambient gas into said enclosure;
(d) a third means to introduce photons into said enclosure;
(e) an aperture in said enclosure;
(f) a fourth means to detect the energy of photoelectrons stimulated from said experimental sample by said photons and leaving said enclosure through said aperture;
(g) a fifth means to produce a photoelectron micrograph

whereby in situ imaging can be at the limit of the spatial resolution of the microscopy technique.

The present invention satisfies the need for an ambient pressure photoelectron microscope for chemical imaging of in situ processes at the limit of the spatial resolution of the microscopy technique

These and other aspects and benefits of the invention will become more apparent upon analysis of the drawings, specification and claims.

### BRIEF DESCRIPTION OF THE SEVERAL VIEWS OF THE DRAWINGS

The invention will be better understood and the objects and advantages of the present invention will become apparent when consideration is given to the following detailed description thereof. Such description makes reference to the annexed drawings wherein:

FIG. 1 is a diagram illustrating the parts of an ambient pressure cell;

FIG. 2 is a block diagram illustrating the structure of an ambient pressure cell;

FIG. 3 is a schematic of a magnetic projection lens.

FIG. 4 is a block diagram illustrating the structure of a photoelectron microscope with an ambient pressure cell.

### DETAILED DESCRIPTION OF THE INVENTION

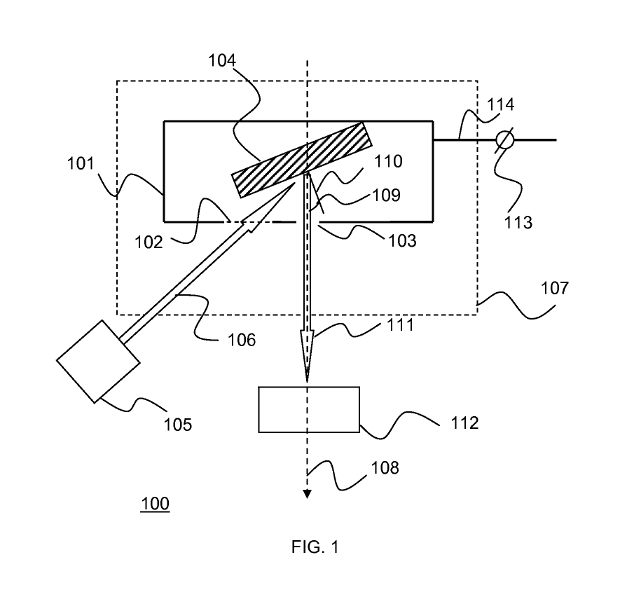

Referring to FIGS. 1 through 4, wherein like reference numerals refer to like components in the various views, there is illustrated therein a new and improved ambient pressure cell.

It is an object of the invention to provide an ambient pressure cell with no requirement for differential pumping. It is a further object of the invention to provide an ambient pressure cell where the ambient gas is largely confined to the pressure cell and scattering of the photoelectron by the gas is minimized. It is a further object of the invention to provide an ambient pressure cell which has much higher working pressures than current art.

The invention described herein is contained in several functional elements and sub-elements individually and combined together to form the elements of an ambient pressure cell that is novel and unobvious. FIG. 1 illustrates the hierarchy, linkages, and general functionality of the elements of the ambient pressure cell 100. The first element is an enclosure 101. The enclosure has a window 102 and an aperture 103. The window 102 is substantially transparent to UV or X-ray radiation. It should be understood that the window 102 and aperture 103 could be coincident, and the aperture 103 would be both a window 102 and an aperture 103. The enclosure 101 substantially encloses the sample 104. It should be understood that the sample 104 need not be a solid, but could be liquid or gas. An illuminator 105 is a source of probe radiation 106 and may collimate, focus, vignette, or otherwise manipulate the probe radiation 106. The probe radiation 106 is a photon beam, either UV or X-rays. The probe radiation 106 irradiates the sample 104 through the window 102 in the enclosure 101. The enclosure 101 and sample 104 are substantially immersed in a magnetic field 107 that has the field direction substantially along an axis 108 joining the sample 104 with the aperture 103. It should be understood that the angle 109 of the sample normal 110 to axis 108 of the magnetic field 107 can be variable. A beam of photoelectrons 111 is created by the action of the probe radiation 106 on the surface of the sample 104. The beam of photoelectrons 111 travels along the axis 108 of the magnetic field 107, and exits the enclosure 101 through the aperture 103. The beam of photoelectrons 111 is subsequently detected, or analyzed, by a detector means 112. A gas inlet valve 113 is used to introduce an ambient gas into the enclosure 101 through a tube 114.

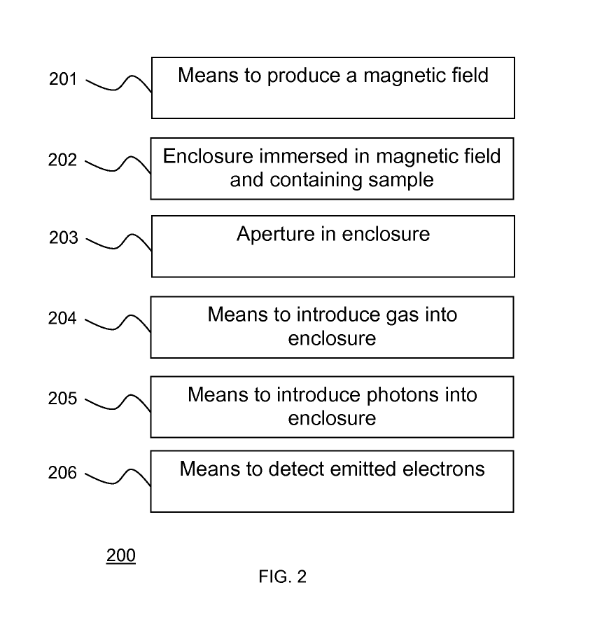

FIG. 2 shows the structure 200 of the ambient pressure cell 100. The ambient pressure cell 100 comprises: a first means 201 to produce the magnetic field 107, an enclosure means 202 which is comprised of the enclosure 101 immersed in the magnetic field 107, and containing an experimental sample 104, an aperture means 203 which is comprised of an aperture 103 in the enclosure 101, a second means 204 to introduce ambient gas into the enclosure 101, a third means 205 to introduce photons into the enclosure 101, and a fourth means 206 to detect emitted electrons.

The enclosure 101 in the preferred implementation substantially traps gas within the volume of the enclosure 101 so that gas introduced into the enclosure 101 by the gas inlet valve 113 and tube 114 can interact with and modify with the surface of the sample 104.

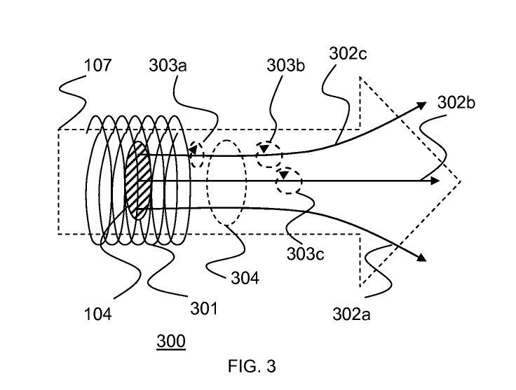

As illustrated in FIG. 3 the magnetic field 107 acts as a projection lens 300. The sample 104 resides in the magnetic field 107. The magnetic field is created by a current carrying solenoid 301. Electrons emitted from the surface of the sample 104 are constrained to move along the magnetic field lines 303a, b, c in cyclotron orbits 303a, b, c which are helices along the field lines 303a, b, c. The aperture position 304 is within the divergence of the magnetic field lines 302a, b, c which lies outside the region of the solenoid. Thus, the cross-sectional area of the beam of photoelectrons 111 leaving the surface of the surface of the sample 104 is substantially the same at the aperture position 304. Thus, the cross-sectional area of the aperture 103 can be made substantially the same as the cross-sectional area of the beam of photoelectrons 111.

The radii of the cyclotron orbits 303a, b, c are determined by the value of the axial magnetic field and the off axis, or radial, component of the electron energy.

The cyclotron orbits 303a, b, c have a maximum radius that is dependent on the energy of the electrons, E, and the magnetic field B in the following relationship:

$${R}_{max} = \frac{{( 2 mE )}^{1 / 2}}{eB}$$

Table 1 gives Rₘₐₓ in microns, μ, for various electron energies in electron Volts, eV, and for two projection lens fields at the sample surface in Tesla, T.

TABLE 1

| Electron energy, eV | 2 T | 10 T |
|---|---|---|
| 1.0 | 1.7μ | 0.337μ |
| 10.0 | 5.3μ | 1μ |
| 0.355 | 17μ | 3.3μ |
| 1.0 | 53μ | 10μ |

A field of 2 T is possible with a permanent magnet assembly while a field of 10 T would be obtained using a superconducting magnet. With a 10 T magnetic field most electrons in the photoelectron beam 111 with an energy below 1000 eV would pass through an aperture 104 of between 1μ and 10μ.

The illuminator 105 can be a variety of photon sources. These photon sources could include a UV laser and X-ray sources such as a monochromatic beam line from a synchrotron. Many of these photon sources are very bright and the probe radiation 106 can be readily focused into a micron sized region on the sample 104.

The aperture 103 can be made as small as the area of the probe radiation 106 at the sample 104, or smaller. As most of the emitted photoelectrons leaving the sample will reach the aperture 103 minus those scattered by the ambient gas, the electrons leaving the aperture 103 will be a significant proportion of those emitted. The aperture size does not need to be bigger than the irradiated area. For example, with a third generation synchrotron the cross section of the irradiating beam 106 can be in the sub 3μ diameter level with 10¹² photons per second. Thus the gas conductance of the aperture which is ‘pinhole’ sized will be far less than the conductance of a prior art aperture of 0.3 mm. The difference in conductance is simply the ratio of the areas and this implies is a factor 10,000:1 difference in the amount of gas flowing into the analyzer chamber. This large difference between the conductance of the prior art and the present disclosure makes differential pumping unnecessary with the ambient pressure cell 100. Thus the design of the subsequent electron detector or analyzer is relatively unconstrained and the apparatus for ambient pressure experiments is considerable simpler. The entire ambient pressure cell 100 can be introduced into an instrument such as described by Browning with no necessity for making the instrument dedicated to one experimental setup. The small size of the aperture 103 means that the sample 104 can be moved closer to the aperture 103. With an aperture 103 diameter of 3μ the sample 104 surface to aperture 103 distance could be made 10μ. This distance compares with the 1 mm distance typical of prior art. Thus the pressure in the ambient pressure cell 100 could be made from 10-100 times greater as the scattering of the electrons will be much less for any ambient gas pressure.

A high pressure of a reactive gas can be used with the ambient pressure cell 100 and other techniques such as heating, or cooling of the sample 104 will enable modification of the sample 104 surface such that modification of the sample 104 can be conveniently analyzed.

As will be clear to someone ordinarily skilled in the art there are a variety of electron detectors or analyzers that could be used with the ambient pressure cell 100, including: a concentric hemispherical analyzer, a cylindrical mirror analyzer, a retarding field analyzer, or time of flight analyzer.

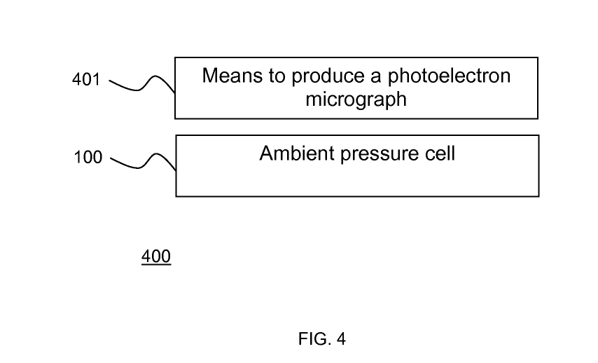

FIG. 4 is a block diagram illustrating the structure of an ambient pressure photoelectron microscope 400. A means to produce a photoelectron micrograph 401 is used to image a sample 104 contained in the ambient pressure cell 100. The means to produce a photoelectron micrograph 401 could be the photoelectron microscope described by Beamson et. al. and Turner, or the microscope described by Browning, as both of these authors describe magnetic immersion lenses. The ambient pressure cell 100 has substantially no requirement for differential pumping, thus mechanical vibration in the region of the sample is low. Low vibration at the sample is a requirement for high resolution microscopy. An ambient pressure photoelectron microscope comprising a means to produce a photoelectron micrograph 401 and an ambient pressure cell 100 comprising a first means 201 to produce the magnetic field 107, an enclosure means 202 which is comprised of the enclosure 101 immersed in the magnetic field 107, and containing an experimental sample 104, an aperture means 203 which is comprised of an aperture 103 in the enclosure 101, a second means 204 to introduce ambient gas into the enclosure 101, a third means 205 to introduce photons into the enclosure 101, and a fourth means 206 to detect emitted electrons, would thus be able to image a sample to the limit of the spatial resolution of the microscopy technique.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

I claim:

1. An experimental apparatus comprising:
(a) a first means producing a magnetic field;
(b) an enclosure immersed in said magnetic field and containing an experimental sample;
(c) an aperture in said enclosure;
(d) a second means to introduce an ambient gas into said enclosure;
(e) a third means to introduce photons into said enclosure;
(f) a fourth means to detect the emitted electrons from said experimental sample by said photons and leaving said enclosure through said aperture;
(g) a fifth means to produce a photoelectron micrograph;
whereby, chemical imaging of the said sample can be achieved at the limits of the spatial resolution of the microscope technique.
